(19) United States
(12) Patent Application Publication
(10) Pub. No.: US 2007/0188808 A1
(43) Pub. Date: Aug. 16, 2007

(54) PRINTING SYSTEM, INFORMATION PROCESSOR, PRINTER, PRINTING MEDIUM, AND COMPUTER-READABLE PROGRAM

(75) Inventor: Naoto TSUBOI, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 11/672,201

(22) Filed: Feb. 7, 2007

(30) Foreign Application Priority Data
Feb. 15, 2006 (JP) 2006-038348

(51) Int. Cl. G06K 15/00

(52) U.S. Cl. 358/1.18

(57) ABSTRACT

A printing system includes a printer performing a printing operation on a printing medium; and an information processor transmitting print information used for the printer to perform the printing operation on the printing medium, wherein the printer includes supporting means for supporting the printing medium for the printing operation and printing means for performing the printing operation on the printing medium on the basis of the print information, wherein the information processor includes editing information processing means for generating or processing editing information on the edition of a layout of the printing medium as information for performing the printing operation on the same printing medium by plural times, display means for displaying the editing information generated or processed by the editing information processing means, and print information generating means for generating the print information on the basis of the editing information when a user requests for performing the printing operation.

### CROSS REFERENCES TO RELATED APPLICATIONS

The present invention contains subject matter related to Japanese Patent Application JP 2006-038348 filed in the Japanese Patent Office on Feb. 15, 2006, the entire contents of which are incorporated herein by reference.

### BACKGROUND OF THE INVENTION

1. Field of the Invention

The present invention relates to a printing system, an information processor, a printer, a printing medium, and a computer-readable program.

2. Description of Related Art

In recent years, optical disks such as a CD-R and a DVD-R which are writable only once or a CD-RW and a DVD-RW which are writable plural times were widely spread as media capable of storing a large volume of information.

An optical disk such as the CD-R has a structure in which a recording layer formed of a pigment, a reflective layer on which gold or silver is deposited, and a protective layer formed of an ultraviolet-curable resin are sequentially disposed on a substrate.

A printer is known which prints characters or figures indicating contents of data recorded in the optical disk on the opposite surface (hereinafter, referred to as ‘label surface’) of a recording surface, on which data is recorded, of the optical disk having the above-mentioned structure (for example, see JP-A-2004-110994).

### SUMMARY OF THE INVENTION

However, when performing the printing operation on a printing medium such as an optical disk again after once performing the printing operation on the printing medium, the objects such as previously printed characters and figures and objects to be newly printed may be overlapped with each other. Accordingly, it was difficult to adjust a position and a direction of the printing medium.

It was not easy to prepare the objects such as the characters and the figures to be printed again by managing the positions of the objects once printed on the printing medium, for example, so as not to be overlapped with each other.

Thus, there is a need for providing new and improved printing system, printer, information processor, printing medium, and computer-readable program capable of performing a printing operation on the printing medium in accordance with a layout of the printing medium even when performing the printing operation on the same printing medium by plural times.

According to a first embodiment of the invention, there is provided a printing system including a printer performing a printing operation on a printing medium and an information processor transmitting print information used for the printer to perform the printing operation on the printing medium. In the printing system, the printer includes supporting means for supporting the printing medium for the printing operation and printing means for performing the printing operation on the printing medium on the basis of the print information and the information processor includes editing information processing means for generating or processing editing information on the edition of a layout of the printing medium as information for performing the printing operation on the same printing medium by plural times, display means for displaying the editing information generated or processed by the editing information processing means, and print information generating means for generating the print information on the basis of the editing information when a user requests for performing the printing operation on the printing medium, wherein the supporting means has a direction matching mechanism matching an attachment direction of attaching the printing medium to the supporting means and the direction of the printing medium and the editing information processing means generates mark information serving as a reference for specifying a direction of the printing medium corresponding to the direction of the printing medium attached to the supporting means in a first mode and transmits the mark information to the display means so as to edit the layout of the printing medium on the basis of the mark information.

The display means may switch the mark information generated by the editing information processing means between a display state and a non-display state on an editing screen.

The direction of the printing medium may be specified by a mark existing on the printing medium. Alternatively, the mark may be a radial line segment from the center of the printing medium.

The editing information processing means may generate or process print editing information for editing an object to be printed on the printing medium in a second mode. By this configuration, when performing the printing operation on the same printing medium by plural times, it is possible to efficiently edit the layout of the printing medium.

The display means may switch the print editing information generated or processed by the editing information processing means between a display state and a non-display state on the editing screen.

The editing information processing means may generate or process non-print editing information on a non-print object which is not printed on the printing medium as an object on the editing screen in a third mode. By this configuration, when performing the printing operation on the same printing medium by plural times, it is possible to efficiently edit the layout of the printing medium.

The display means may switch the non-print editing information generated or processed by the editing information processing means between a display state and a non-display state on the editing screen.

The non-print editing information may be information on an object having been previously printed on the printing medium.

The non-print editing information may be at least information indicating an area to be printed on the printing medium. Alternatively, the non-print editing information may be print-prepared editing information on an area not to be printed at this time and to be printed before long.

The printing system includes mode selecting means for selecting any one of a second mode for generating or processing the print editing information for editing the object to be printed on the printing medium and a third mode for generating or processing non-print editing information on the non-print object not to be printed on the printing medium and the editing information processing means may generate or process the editing information corresponding to the mode selected by the mode selecting means.

The printing system includes mode selecting means for selecting any one of modes (1) to (3) of (1) the first mode for generating the mark information serving as the reference for specifying the direction of the printing medium corresponding to the direction of the printing medium attached to the supporting means, (2) the second mode for generating or processing the print editing information for editing the object to be printed on the printing medium, and (3) the third mode for generating or processing the non-print editing information on the non-print object not to be printed on the printing medium and the editing information processing means may generate or process the editing information corresponding to the mode selected by the mode selecting means.

The display means may include the display switching means switching so as to display at least one of the print editing information and the non-print information.

The editing information processing means may judge whether an object to be printed on the printing medium and the non-print object not to be printed on the printing medium are overlapped with each other and generate overlap information indicating an overlapped part when it is judged that the objects are overlapped with each other. The display means may display the overlap information generated by the editing information processing means on the editing screen.

The object may be formed of characters, signs, or figures, a mixture of the characters, signs, and figures, or a mixture of the characters, signs, and figures and colors.

The display means may display mark printing or non-printing reception information for receiving whether the mark is printed on the printing medium.

When the printing medium does not have the mark, the printing means may print the mark on the printing medium.

According to a second embodiment of the invention, there is provided the information processor for generating the print information and performing the printing operation on the printing medium. Since the information processor has a substantially same configuration as the information processor disposed in the printing system described above, a detailed description thereof will be omitted.

According to a third embodiment of the invention, there is provided the printer for reading print information and performing the printing operation on the printing medium. Since the printer has the substantially same configuration as the printer disposed in the printing system described above, a detailed description thereof will be omitted.

According to a fourth embodiment of the invention, there is provided the printing medium on which the printing operation is performed by the printer for reading the print information. The printer includes supporting means for supporting the printing medium for the printing operation and printing means for performing the printing operation on the printing medium on the basis of the print information, wherein the print information is generated on the basis of the editing information on the edition of the layout of the printing medium for performing the printing operation on the same printing medium by plural times, and wherein the printing medium includes a mark clearly specifying the direction of the printing medium to match the attachment direction of attaching the printing medium to the supporting means with the direction of the printing medium.

According to a fifth embodiment of the invention, there is provided a computer-readable program enabling a computer to serve as an information processor generating print information for performing the printing operation on a printing medium. The computer-readable program includes an editing information processing function of generating or processing editing information on the edition of the layout of the printing medium as information for performing the printing operation on the same printing medium by plural times; a display function of displaying the editing information generated or processed by the editing information processing function on an editing screen; and a print information generating function of generating the print information on the basis of the editing information when a user requests for performing the printing operation on the printing medium, wherein the printing medium is supported by supporting means disposed in a printer and a direction of attaching the printing medium to the supporting means and a direction of the printing medium are matched with each other, and wherein the editing information processing function generates mark information serving as a reference for specifying a direction of the printing medium corresponding to the direction of the printing medium attached to the supporting means and transmits the mark information to the display function so as to edit the layout of the printing medium on the basis of the mark information, in a first mode.

The display function may switch the mark information generated by the editing information processing function between the display state and the non-display state on the editing screen.

The editing information processing function may generate or process the print editing information for editing the object to be printed on the printing medium in a second mode.

The display function may switch the print editing information generated or processed by the editing information processing function between the display state and the non-display state on the editing screen.

The editing information processing function may generate or process non-print editing information on a non-print object not to be printed on the printing medium as an object on the editing screen in a third mode.

The display function may switch the non-print editing information generated or processed by the editing information processing function between the display state and the non-display state on the editing screen.

The non-print editing information may be information on an object having been previously printed on the printing medium. Alternatively, the non-print editing information may be information at least indicating an area to be printed on the printing medium.

The information processor includes a mode selecting function of selecting at least one of the second mode for generating or processing the print editing information for editing the object to be printed on the printing medium and the third mode for generating or processing the non-print editing information on the non-print object not to be printed on the printing medium, wherein the editing information processing function may generate or process the editing information corresponding to the mode selected by the mode selecting function.

The editing information processing function may judge whether an object to be printed on the printing medium and the non-print object not to be printed on the printing medium are overlapped with each other and generate overlap information indicating an overlapped part when it is judged that the objects are overlapped with each other. The display function may display the overlap information generated by the editing information processing means on the editing screen.

The display function may display mark printing or non-printing reception information for receiving whether the mark is printed on the printing medium.

### BRIEF DESCRIPTION OF THE DRAWINGS

FIG. 1 is a block diagram illustrating an example of a schematic configuration of a printing system according to an embodiment of the invention.

FIG. 2 is a block diagram illustrating an example of a schematic configuration of a printer according to an embodiment of the invention.

FIGS. 3A and 3B are explanary views illustrating an example of a schematic configuration of a print tray according to an embodiment of the invention.

FIG. 4 is a schematic block diagram illustrating an example of a hardware configuration of an information processor according to an embodiment of the invention.

FIG. 5 is a schematic explanary view illustrating modules serving as an information processor according to an embodiment of the invention.

FIG. 6 is an explanary view illustrating an example of a schematic configuration of an editing screen according to an embodiment of the invention.

FIG. 7 is an explanary view illustrating an example of a schematic configuration of an editing screen according an embodiment of the invention.

FIG. 8 is an explanary view illustrating an example of a schematic configuration of an editing screen according to an embodiment of the invention.

FIG. 9A is a flowchart illustrating a schematic print processing in a printing system according to an embodiment of the invention.

FIG. 9B is a flowchart illustrating schematic multiple print processings in a printing system according to an embodiment of the invention.

FIGS. 10A to 10C are explanary views illustrating schematic multiple print processings on a label surface of an optical disk according to an embodiment of the invention.

FIGS. 11A to 11C are explanary views illustrating schematic multiple print processings on a label surface of an optical disk according to an embodiment of the invention.

### DETAILED DESCRIPTION OF THE INVENTION

Hereinafter, pertinent embodiments of the invention will be specifically described with reference to the accompanying drawings. In the following descriptions and accompanying drawings, the same reference numeral is given to a constituent element having the same function and the same configuration, whereby a duplicate description will be omitted.

Printing System

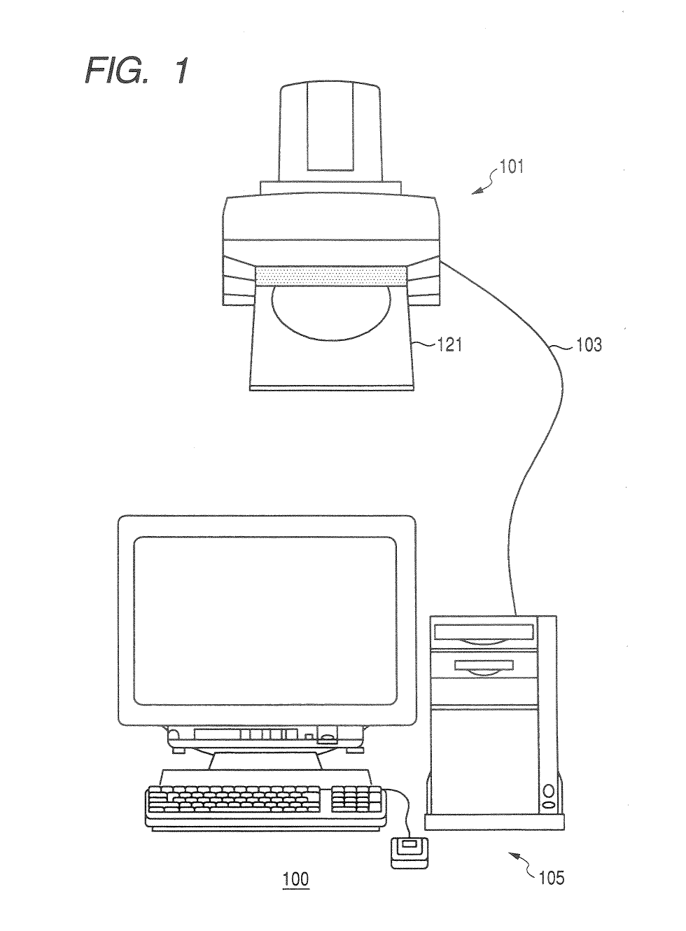

First, referring to FIG. 1, the embodiment describes a printing system 100. FIG. 1 is a block diagram illustrating an example of a schematic configuration of a printing system according to the embodiment of the invention.

As shown in FIG. 1, the printing system 100 includes a printer 101 and an information processor 105. The printer 101 and the information processor 105 are connected with each other via a network 103.

The printer 101 has a print tray 121 and prints objects such as characters or figures on a label surface of the optical disk such as a CD-ROM placed on the print tray 121. The printer 101 is not limited to a case where the objects are printed on the label surface of the optical disk, but may print the objects on a paper medium, and the like.

The label surface of the optical disk according to the embodiment of the invention is set to an opposite surface of a recording surface on which data is recorded in the optical disk, but it is not limited to the example.

The network 103 connects the printer 101 to the information processor 105 and generally includes a cable such as a USB (Universal Serial Bus) or an RS-232C. However, the network 103 may include a coaxial or a twisted-pair cable by Ethernet (registered trademark), a wireless network by IEEE802.11b, or a satellite communication network irrespective of a wired network or a wireless network.

The information processor 105 prepares or processes the objects such as the characters or the figures to be printed on the label surface of the optical disk and generates print information used for printing the objects on the label surface of the optical disk.

In the printing system 100 configured as described above, when the information processor 105 prepares the object to be printed on the label surface of the optical disk or determines the layout of the label surface, the printer 101 performs a printing operation on the label surface of the optical disk placed in the print tray 121 in accordance with the determined layout of the label surface.

That is to say, the printing system 100 can determine the layout of the label surface by preparing a new object so as not to be overlapped with the previously printed object at the time of performing the printing operation by plural times. The printer 101 can perform the printing operation in accordance with the layout of the label surface, thereby preventing the objects from being overlapped with each other even when performing the printing operation on the same label surface of the optical disk by plural times.

Since the information processor 105 manages editing information on the object previously printed on the same label surface of the optical disk or an object to be newly printed on the label surface at this time and the printer 101 has a mechanism matching a direction of attaching the optical disk to the print tray 121 with a direction of the optical disk, it is possible to perform the printing operation on the label surface in accordance with an edited layout.

The editing information managed by the information processor 105 or the mechanism which is disposed in the print tray 121 of the printer 101 and matches the directions will be described later.

In the embodiment, the object denotes, for example, characters, signs, and figures, a mixture of those, or a mixture of those and colors, but it is not limited to the example. The figures include an image of a person, and the like. The color of the object is not limited to white, black, or gray, but may be any color.

A case where the printing system 100 shown in FIG. 1 includes a single printer 101 and a single information processor 105 is exemplified, but the invention is not limited to the example. For example, the printing system 100 may include a plurality of printers 101 and/or a plurality of information processors 105.

A case where the printing system 100 described below includes the printer 101 and the information processor 105 is exemplified, but it is not limited to the example. For example, the printing system 100 may include the only printer 101. In this case, the printer 101 includes at least one of functions of the information processor 105.

Printer

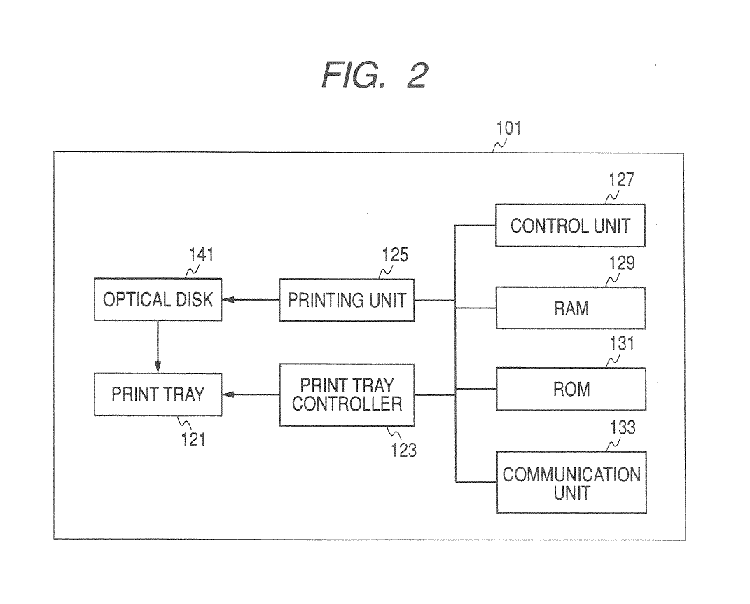

Next, referring to FIG. 2, the embodiment describes a hardware configuration of the printer 101. FIG. 2 is a block diagram illustrating an example of a schematic configuration of the printer according to the embodiment of the invention.

As shown in FIG. 2, the printer 101 at least includes a print tray 121, a print tray controller 123, a printing unit 125, a control unit 127, a RAM (Random Access Memory) 129, a ROM (Read-Only Memory) 131, a communication unit 133, and an optical disk 141 which is one of printing media. The optical disk 141 is placed in the print tray 121, whereby the printer 101 includes the optical disk 141.

The print tray controller 123 drives the print tray 121 depending on an command from the control unit 127 and moves the print tray 121 inward or outward to control the in and out movement of the print tray 121.

The printing unit 125 prints the object on the label surface of the optical disk 141 depending on the command from the control unit 127.

The printing unit 125, for example, includes a bottle filled up with ink used for the printing operation or a nozzle discharging the ink, but it is not limited to the example. For example, the printing unit 125 may include a toner or a photoconductive drum disposed in an electrophotographic printer.

The color which the printing unit 125 can print on the label surface of the optical disk 141 is not limited to monochrome and it may be color.

The control unit 127 commands processes to the units such as the print tray controller 123, the printing unit 125, the RAM 129, the ROM 131, and the communication unit 133 disposed in the printer 101 and controls processes executed by the corresponding units.

A program (for example, a firmware, etc.) used for various processings of performing the printing operation on the label surface and driving the print tray 121, which is executed by the control unit 127 on the basis of print information received from the information processor 105 is stored (installed) in the ROM 131.

That is, the control unit 127 according to the embodiment of the invention executes the program stored in the ROM 131, thereby permitting the printing unit 125 to perform the printing operation on the label surface of the optical disk 141 attached to the print tray 121.

The communication unit 133 receives the print information from the information processor 105 via a network 103 or transmits end information informing the information processor 105 of the end of print via the network 103. The communication unit 133 transmits and receives data via the network 103 as described above.

The optical disk 141 includes media such as an MO, a CD-ROM, a DVD-ROM, a DVD-R, and a CD-R capable of storing data by using light such as a laser beam, but it is not limited to the example. The optical disk 141 may include other media.

As shown in FIG. 2, a case where the printer 101 according to the embodiment of the invention includes the print tray controller 123 is exemplified, but it is not limited to the example. For example, the printer 101 may not include the print tray controller 123. In this case, the print tray 121 is manually moved in and out by a user.

Print Tray

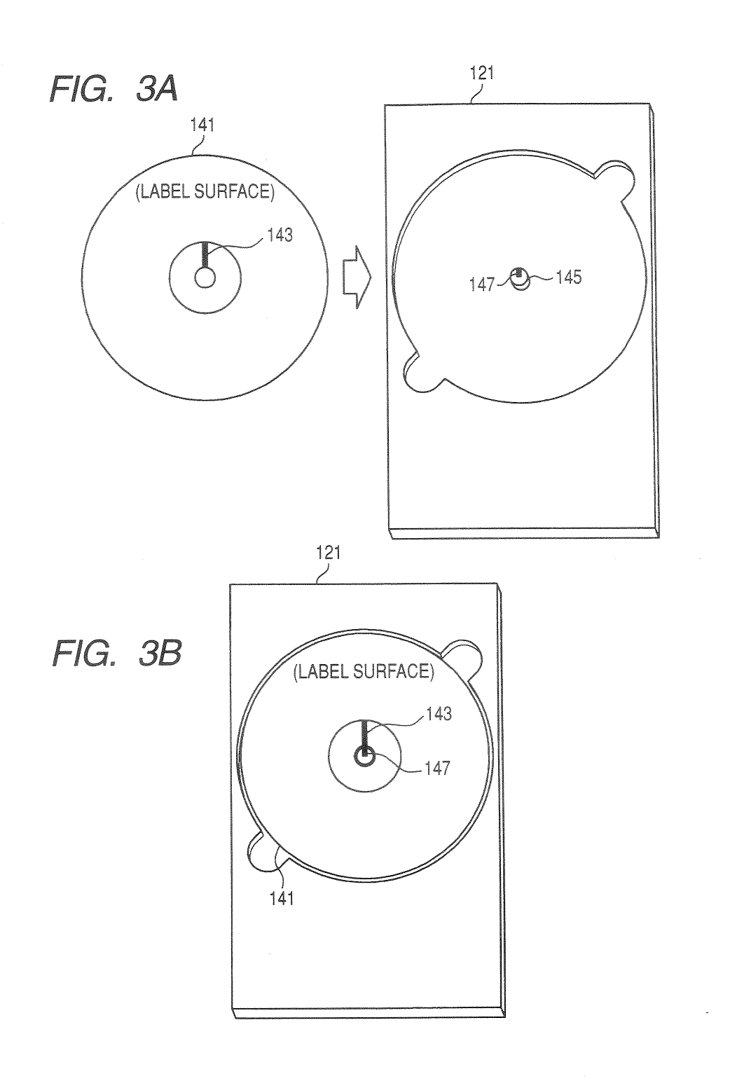

Next, referring to FIGS. 3A and 3B, the embodiment describes the print tray 121. FIGS. 3A and 3B are explanary views illustrating an example of a schematic configuration of the print tray according to the embodiment of the invention.

The optical disk 141 shown in FIG. 3A has a general shape, but it is different from a general optical disk in that a line is radially drawn from the center and a mark 143 exists on a surface of the disk.

The mark 143 is provided on the surface of the optical disk 141, thereby specifying the direction of the optical disk 141. In the past, since the mark 143 is not definitely shown, it was difficult to specify, particularly, the direction of a circular-shaped optical disk.

A fixing member 145 which fits in a central opening formed in the center of the optical disk 141 and fixes the optical disk 141 is formed in the print tray 121 shown in FIG. 3A.

The central opening of the optical disk 141 fits in the fixing member 145, whereby attaching the optical disk 141 to the print tray 121.

Meanwhile, when the optical disk 141 is separated from the print tray 121, the central opening of the optical disk 141 is released from the fixing member 145, whereby separating the optical disk 141 from the print tray 121.

As shown in FIGS. 3A and 3B, an attachment mark 147 used to determine the direction of attaching the optical disk 141 to the print tray 121 is disposed in the fixing member 145. For example, the attachment mark 147 may be printed on the fixing member 145 with ink or may be formed on the fixing member 145 in a shape such as a convex shape recognizable as the attachment mark 147. Accordingly, the attachment mark 147 may have all the forms.

The optical disk 141 is attached to the print tray 121 so that the mark 143 and the attachment mark 147 shown in FIG. 3A are matched with each other (so that lines are linear with each other), that is, so that the direction of attaching the optical disk 141 to the print tray 121 and the direction of the optical disk 141 are matched with each other as shown in FIG. 3B.

As described above, the print tray 121 has the fixing member 145 and the attachment mark 147 as a direction matching mechanism capable of matching the direction of attaching the optical disk 141 to the print tray 121 with the direction of the optical disk 141 by using the mark 143.

As shown in FIG. 3B, even though the optical disk 141 is separated from the print tray 121, it is possible to clearly determine the direction of the optical disk 141, the position of the optical disk 141, and a range printable on the label surface of the optical disk 141 by matching the attachment mark 147 with the mark 143.

Accordingly, when the layout of all objects is managed, it is possible to perform additional printing operations including an operation of printing the objects while slowly increasing the number of the objects on the label surface of the optical disk 141 at the time of performing the printing operation by plural times. The management of the layout of the objects to be printed on the label surface of the optical disk 141 is performed by the information processor 105. However, a detailed description thereof will be described later.

A case where the line is radially drawn from the fixing member 145 so that the attachment mark 147 shown in FIGS. 3A and 3B is matched with the mark 143 of the optical disk 141 which is the printing medium is exemplified. However, when the attachment mark 147 serves as a reference for clearly determining the direction of attaching the optical disk 141 to the print tray 121, the attachment mark 147 is not limited to the example. For example, the attachment mark 147 may have all the forms including a reticular line, a spot, and a triangular shape. The attachment mark 147 also may be positioned in locations other than the fixing member 145.

A case where the line is radially drawn from the center of the optical disk 141 is exemplified with reference to the mark 143 shown in FIGS. 3A and 3B. However, when the mark 143 is a reference used for clearly determining the direction of the optical disk 141, the mark 143 is not limited to the example. For example, the mark 143 may have all the forms a reticular line and spot, or a triangular shape. The mark 143 also may be positioned in all locations on the surface of the optical disk 141.

A case where the mark 143 is separately disposed in the center of the optical disk 141 is exemplified, but it is not limited to the example. For example, the mark 143 may be one number of manufacturing numbers having been previously printed on the surface of the optical disk 141 or one bar of bar codes having been previously printed.

Information Processor

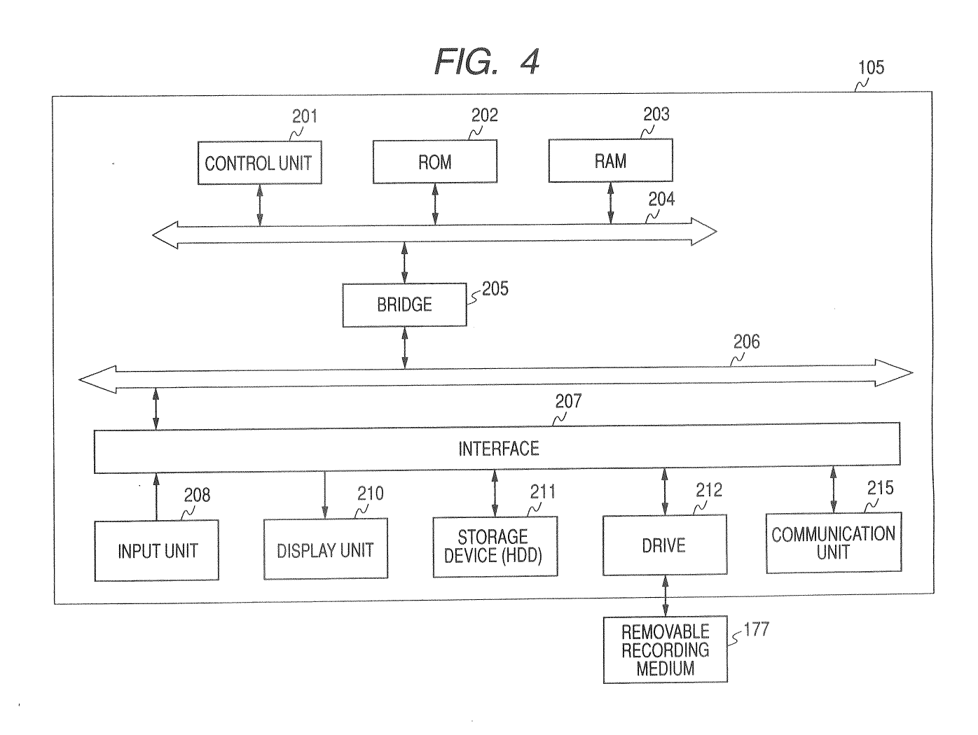

Next, referring to FIG. 4, the embodiment describes a hardware configuration of the information processor 105. FIG. 4 is a schematic block diagram illustrating an example of a hardware configuration of the information processor according to the embodiment of the invention.

As shown in FIG. 4, the information processor 105 includes, for example, a control unit 201 corresponding to a CPU (Central Processing Unit), a ROM 202, a RAM 203, a host bus 204, a bridge 205, an extended path 206, an interface 207, an input unit 208, a display unit 210, a storage device (HDD) 211, a drive 212, and a communication unit 215.

The control unit 201 serves as a processing unit and a control unit, operates in accordance with various programs, and controls the units in the information processor 105. The ROM 202 stores a program or an operation parameter used by the control unit 201. The RAM 203 primarily stores the program used for executing the control unit 201 or the parameter suitably changed at the time of executing the control unit 201. The ROM 202 and the RAM 203 are connected to each other by a host bus 204 serving as an external bus.

The host bus 204 is connected to an extended bus 206 such as a PCI (Peripheral Component Interconnect/Interface) bus via the bridge 205.

The input unit 208 includes manipulating means such as a mouse, a keyboard, a touch panel, a button, a switch, and a lever and an input controlling circuit generating an input signal to output the input signal to the control unit 201.

A user who uses the information processor 105 may prepare the object or command a processing operation such as a printing operation by manipulating the input unit 208, for example, by inputting various data to the information processor 105.

The input unit 208 is not limited to the example described above. For example, when the input unit 208 has optical reading means and detects the editing information by making the optical reading means read data recorded in the optical disk 141, the input unit 208 may automatically generate a request signal for editing the object involved in the editing information.

As described later, the editing information includes print editing information and non-print editing information. The input unit 208 generates a request signal for editing the object involved in at least one of the print editing information and the non-print editing information.

Either hardware means or software means may be used for detecting the editing information in the input unit 208. As described later, in the embodiment, a data management module 309 serving as a program detects the editing information.

As a modified example of the input unit 208, when the input unit 208 detects the editing information from data of the optical disk 141 read by the drive 212, the input unit 208 may automatically generate the request signal for editing the object involved in the editing information without a user's manipulation.

For example, the display unit 210 corresponds to a CRT (Cathode Ray Tube) display device and a liquid crystal display (LCD) device. For example, the display unit 210 outputs edited objects printed on the label surface of the optical disk 141 on a screen

For example, the operation of editing the object according to the embodiment includes an operation of preparing a new object and an operation of deleting the object in addition to an operation of changing the attributes of the object such as an operation of changing the shape of the object, an operation of changing the color of the object, an operation of shifting the position of the object, and an operation of converting the print editing information to the print-prepared editing information, but it is not limited to the example.

The storage device 211 is a device for storing data configured as an example of a storing unit of the information processor 105 and includes, for example, a HDD (Hard Disk Drive). The storage device 211 stores the program executed by the control unit 201 or various data by driving a hard disk serving as a storage medium.

The drive 212 is a rewriter for the storage medium and is built in the information processor 105 or is externally attached to the information processor 105. The drive 212 can read or record data such as the editing information with respect to a removable storage medium 177 such as a magnetic disk, an optical disk, a magneto-optical disk, or a semiconductor memory loaded on the information processor 105.

For example, the communication unit 215 is a communication interface constituted by a communication device for transmitting and receiving data to and from the printer 101 via the network 103. The communication unit 215 is not limited to the network 103. For example, the communication unit 215 may receive data of the editing information from a server on Internet or transmit data of requesting the editing information of the server.

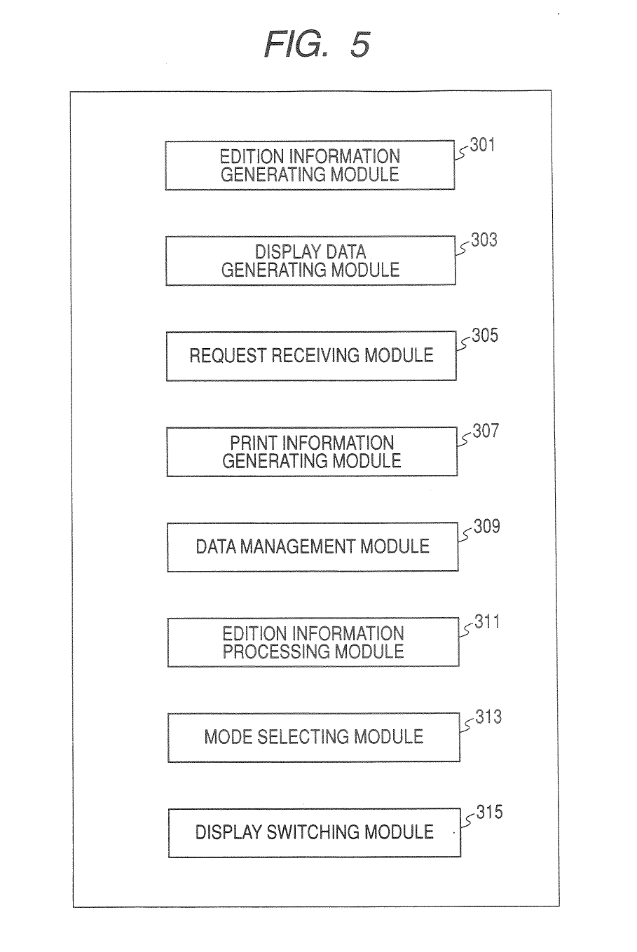

Next, referring to FIG. 5, the embodiment describes modules serving as the information processor 105. FIG. 5 is a schematic explanary view illustrating the modules serving as the information processor according to the embodiment of the invention.

As shown in FIG. 5, the storage device 211 of the information processor 105 includes modules such as an editing information generating module 301, a display data generating module 303, a request reception module 305, a print information generating module 307, a data management module 309, an editing information processing module 311, a mode selecting module 313, and a display switching module 315 serving as the information processor 105 according to the embodiment.

For example, the modules are installed in the storage device 211 via the optical disk or Internet.

For example, the modules are executed by being called from the storage device 211 to the RAM 203 by the control unit 201 as necessary, but are not limited to the example. For example, the modules may executed by being called directly from the ROM 202 and may be executed by being downloaded to the RAM 203 from a network such as Internet as necessary.

The editing information generating module 301 is a program of generating the editing information. The editing information serves as information used for editing the layout of the label surface including an operation of editing the object to be printed on the label surface of the optical disk 141 or an operation of clearly managing the object printed on the label surface of the same optical disk 141 in the past.

For example, the editing information includes the print editing information used for editing an object to be printed at this time, the non-print editing information on a previously-printed object, the print-prepared editing information on an object or an area not to be printed at this time and to be printed before long. However, the editing information will be specifically described later.

The display data generating module 303 is a program generating the display data displayed on an editing screen on the basis of the editing information. The generated display data is transmitted to the display unit 210 and is displayed on the editing screen.

The request reception module 305 is a program capable of receiving a request for performing the printing operation or preparing the editing information by the user's manipulating the input unit 208. A module pertinent to the request received by the request reception module 305 is judged by the control unit 201 and the module is executed.

The print information generating module 307 is a program generating the print information for performing the printing operation on the basis of the print editing information when the request for performing the printing operation is received by the request reception module 305.

The data management module 309 is a program preserving the editing information including at least one of the print editing information, the non-print editing information, and the print-prepared editing information in, for example, the storage device 211 or the removable recording medium 177.

The data management module 309 is a program reading the editing information designated via the input unit 208 by the user from, for example, the storage device 211 or the removable recording medium 177. The data management module 309 is not limited to the example. The data management module 309 may detect the editing information from data recorded in the optical disk 141 in conjunction with the loading of the optical disk 141 by the input unit 208.

The editing information processing module 311 is a program processing the object involved in the editing information generated by the editing information generating module 301 or the editing information read by the data management module 309.

The editing information processing module 311 may perform an operation of changing the attribute of the object including an operation of changing the object involved in the print editing information to the object as the print-prepared editing information or an operation of changing the object involved in the non-print editing information to the object as the print editing information.

More specifically, for example, when the editing information is preserved after the printing operation is performed, the editing information processing module 311 changes all objects involved in the print editing information to the object as the non-print editing information having been previously printed.

The mode selecting module 313 is a program selecting whether the editing information processing module 311 processes the print editing information or the non-print editing information as the mode (edit mode) A command of the selected edit mode is received to the request reception module 305 via the input unit 208 by the user.

The display switching module 315 is a program capable of switching an object to be displayed on the screen of the display unit 210.

More specifically, the display switching module 315 acquires the editing information designated by the user from the request reception module 305 and the display switching module 315 commands the display data generating module 303 to generate the display data on the basis of the designated editing information.

Accordingly, for example, the display switching module 315 permits the print editing information, the non-print editing information, or the print editing information and the non-print editing information out of the editing information to be displayed on the screen.

As described above, the embodiment describes the modules serving as the information processor 105. At least one of the editing information generating module 301, the display data generating module 303, the request reception module 305, the print information generating module 307, the data management module 309, the editing information processing module 311, the mode selecting module 313, and the display switching module 315 may be formed of not a program but a hardware having the functions of the modules.

Editing Screen

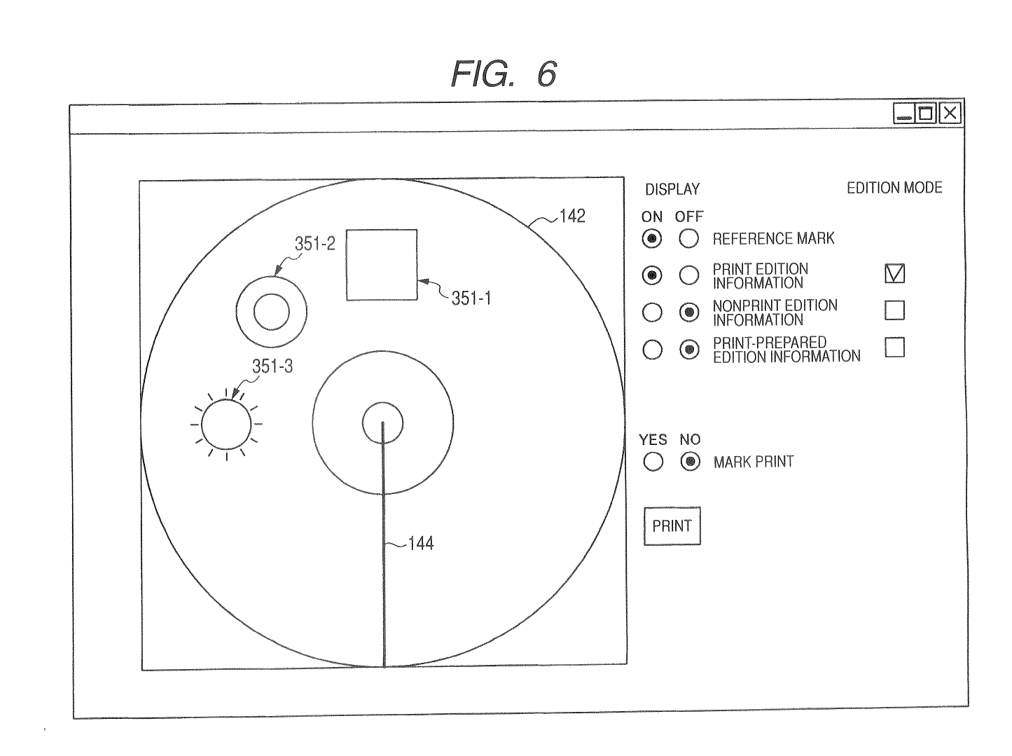

Next, referring to FIGS. 6 to 8, the embodiment describes the editing screen displayed on the screen of the display unit 210. FIGS. 6 to 8 are explanary views illustrating an example of a schematic configuration of the editing screen according to an embodiment of the invention.

The editing screen shown in FIG. 6 is a screen displaying data (print editing information) for editing the object to be printed on the label surface of the optical disk 141 at this time. As shown in FIG. 6, “check” is displayed in a check box of the ‘print editing information’ of the edit mode by manipulating the input unit 208 so as to edit the object involved in the print editing information.

When the request reception module 305 receives a request for selecting the edit mode in the editing information including “check” given to the check box, the mode selecting module 313 changes the edit mode so as to edit the editing information such as the selected print editing information, and the like.

As shown in FIG. 6, whether a ‘reference mark’ is displayed on the editing screen can be determined by selecting any one of radio buttons for the “ON/OFF” display with the input unit 208.

When the radio button related to an “ON” display of the ‘reference mark’ is selected by the input unit 208, the mark 144 radially drawn from the center of the optical disk 142 is displayed on the editing screen

The optical disk 142 is a virtual optical disk displayed on the screen, but corresponds to the optical disk 141. The layout on the label surface of the optical disk 142 displayed on the screen and the layout on the label surface of the optical disk 141 correspond to each other.

The mark 144 clearly determining the direction of the optical disk 142 is a virtual mark displayed on the screen, but corresponds to the mark 143 disposed in the existent optical disk 141. The user can determine the layout of the label surface including the position of the object to be printed on the label surface on the basis of the mark 144 displayed on the editing screen.

When the request reception module 305 receives that the radio button of the “ON” display of the reference mark is selected by the input unit 208, the display switching module 315 commands the display data generating module 303 to generate the display data including the mark 144 on the editing screen.

Similarly, with respect to the ‘print editing information’ shown in FIG. 6, when the radio button related to the “ON” display of the “print editing information” is selected by the input unit 208, the object related to the print editing information disposed on the label surface of the optical disk 142 is displayed on the editing screen.

As shown in FIG. 6, an object 351 (351-1, 351-2, and 351-3) related to the print editing information such as “□” or “⊚” is displayed on the label surface of the optical disk 142 in solid line. The object 351 is prepared by the editing information processing module 311 depending on the user's command.

The editing information processing module 311 permits a plurality of prepared objects to be disposed in a pertinent position of the label surface so as to be helical from the center of the optical disk. As shown in FIG. 6, the disposed objects are displayed on the editing screen as the print editing information.

The radio buttons of “YES/NO” of a ‘mark print’ shown in FIG. 6 are used for selecting whether the mark 143 is printed in a predetermined position of the actual optical disk 141.

When the radio button of “Yes” of the ‘mark print’ is selected by the input unit 208 and then, ‘print’ button is selected, the print information generating module 307 generates the print information on the basis of the print editing information including the print information for printing the mark 143.

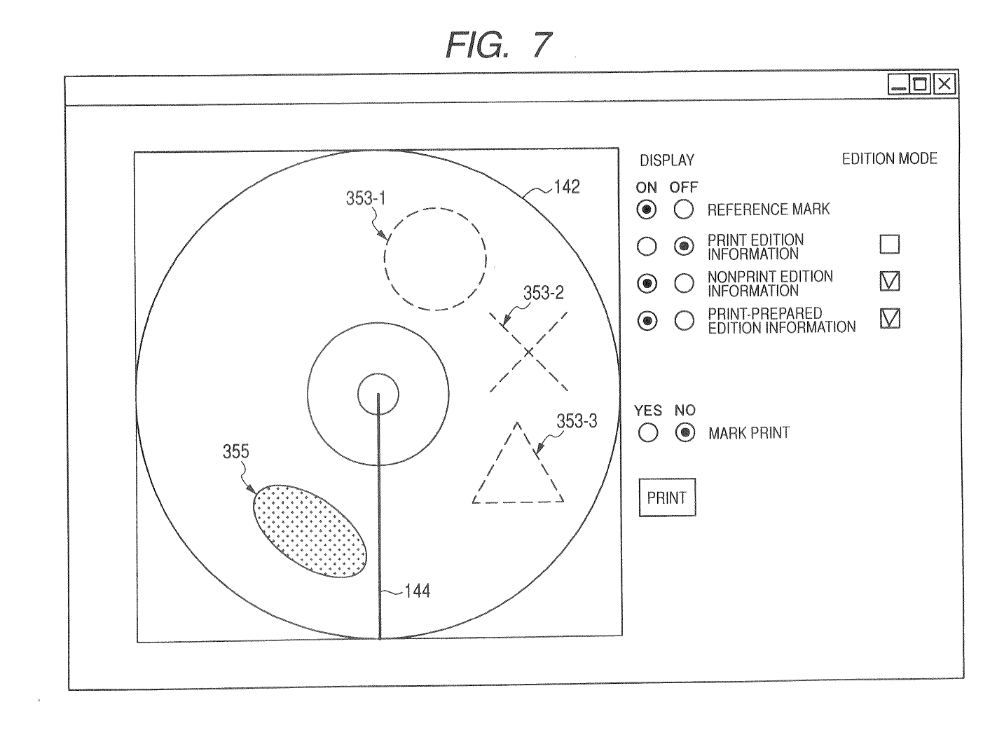

Next, the editing screen shown in FIG. 7 is a screen displaying data (non-print editing information and print-prepared editing information) for displaying or editing the object having been previously on the label surface of the optical disk 141 and not to be printed at this time.

The print-prepared editing information is data belonging to a category of the non-print editing information in that the area or the object is not printed at this time, as data displaying or editing the area or the object which is not printed at this time, but to be printed before long. Accordingly, when particularly not described, the non-print editing information includes the print-prepared editing information.

As shown in FIG. 7, “check” is displayed in a check box of the ‘non-print editing information’ and the ‘print-prepared editing information’ of the edit mode by manipulating the input unit 208 so as to edit the object involved in the non-print editing information and the object or the area involved in the print-prepared editing information. Since the cases of the ‘non-print editing information’ and the ‘print-prepared editing information’ are substantially the same as the case of the ‘print editing information’ with respect to the other points, a detailed description thereof will be omitted.

Similarly to the ‘print editing information’ shown in FIG. 6, with respect to the ‘non-print editing information’ shown in FIG. 7, when the radio button related to the display “ON” of the ‘non-print editing information is selected by the input unit 208, the object of the non-print editing information having been previously printed on the label surface of the optical disk 142 is displayed on the editing screen.

As shown in FIG. 7, an object 353 (353-1, 353-2, and 353-3) of the non-print editing information is displayed on the label surface of the optical disk 142 in broken line. The object 353 is an object having been related to the print editing information in the past and is the object printed on the label surface of the optical disk 141. The object 353 is prepared and disposed by the editing information processing module 311 depending on the user's command.

Similarly, with respect to the ‘print-prepared editing information’ shown in FIG. 7, when the radio button related to the “ON” display of the ‘print-prepared editing information’ is selected by the input unit 208, the object or the area of the print-prepared editing information disposed on the label surface of the optical disk 142 is displayed on the editing screen.

As shown in FIG. 7, an area 355 of the print-prepared editing information is displayed on the label surface of the optical disk 142. The area 355 indicates an area to be printed and all objects can be disposed in the area 355. The area 355 is prepared and disposed by the editing information processing module 311 depending on the user's command.

When the ‘print’ button shown in FIG. 7 is selected, the print information generating module 307 generates the print information on the basis of the print editing information managed in association with the non-print editing information not displayed.

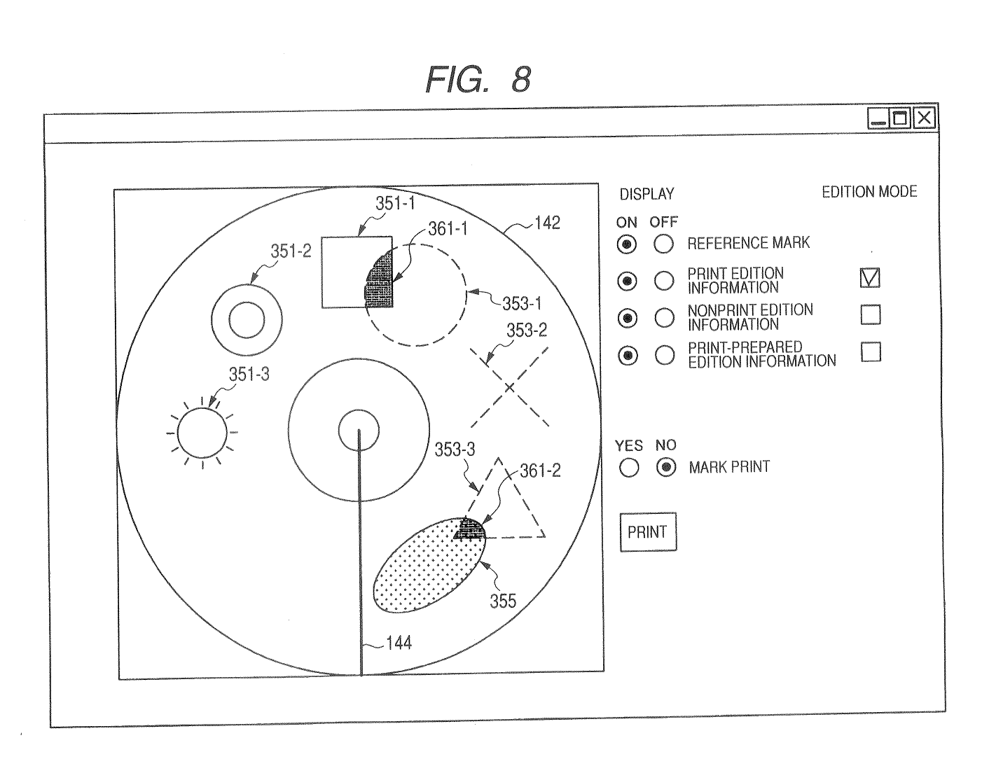

Next, the editing screen shown in FIG. 8 is a screen displaying the objects involved in all editing information of the print editing information, the non-print editing information, and the print-prepared editing information described above.

As shown in FIG. 8, the radio button related to the “ON” display of the ‘print editing information’, the ‘non-print editing information’, and the ‘print-prepared editing information’ is selected by the input unit 208 so as to display the objects involved in all editing information.

As shown in FIG. 8, since the editing screen displays the object 351 involved in the print editing information, the object 353 involved in the non-print editing information, and the area 355 (or object) involved in the print-prepared editing information, the user can easily know the previously-prepared object or the print-prepared area and efficiently edit the layout of the label surface.

The editing screen displays overlap information 361 indicating a part overlapped among the object 351, the object 353, and the area 355.

The editing information processing module 311 judges whether the part overlapped among the objects exits with respect to the objects involved in all editing information disposed on the label surface in association with the overlap information 361. When the overlapped part exists, the object is generated as overlap information 361.

As shown in FIG. 8, in the overlap information 361 (361-1 and 361-2) generated by the editing information processing module 311, the overlapped part, for example, is hatched in gray and displayed on the editing screen, but it is not limited to the example. When the display of the object having the overlapped part is “OFF”, the overlap information 361 is not displayed on the screen.

As described above, since the object printed in the past or the object to be printed before long is displayed on the editing screen shown in FIGS. 6 to 8 in addition to the object to be printed at this time, it is possible to improve the user's editing efficiency. Further, the mark 144 corresponding to the mark 143 of the optical disk 141 is displayed on the screen. Accordingly, even when the layout of the label surface displayed on the editing screen is printed on the label surface by plural times, the layout of the label surface displayed on the editing screen can be printed on the label surface of the actual optical disk 141 as it is (WYSIWYG).

As shown in FIG. 8, the information indicating the part overlapped among the object 351, the object 353, and the area 355 is exemplified, but it is not limited to the example. For example, even though the overlapped part exists among a plurality of objects 351, among a plurality of objects 353, or among a plurality of areas 355, the overlap information 361 may be generated.

As described above, when the ‘print’ button shown in FIGS. 6 to 8 is selected, the print information is generated on the basis of the print editing information. After the print information is generated, the print editing information is preserved in the storage device 211 together with the non-print editing information having been previously generated by the data management module 309 as the editing information (non-print editing information) having been previously printed on the label surface.

As shown in FIGS. 6 to 8, a case where the radio button for selecting whether the mark 143 is printed in the optical disk 141 is displayed on the editing screen is exemplified, but it is not limited to the example. For example, apart from the editing screen, there may be a case where a screen for selecting whether the mark 143 is printed in the optical disk 141 is displayed, a case where the editing information is newly generated, or a case where the print information generating module judges whether the mark 143 is be automatically printed for the printing operation by providing the editing information with a flag indicating whether the mark 143 exists.

The mark 144 shown in FIGS. 6 to 8 all is described as holding up a line segment drawn downward perpendicularly from the center of the optical disk 142 as an example. However, when it is possible to clearly determine the direction of the optical disk in correspondence with the mark 143 of the optical disk 141, the mark 144 is not limited to the example and the mark 144 may have all the forms.

On the editing screen shown in FIGS. 6 to 8, a case where an icon such as the radio button or the check box is displayed is exemplified. However, when it is possible to selectively display or edit the mark 144 (reference mark), the print editing information, the non-print editing information, and the print-prepared editing information, the editing screen is not limited to the example, but any layout, screen, or icon may be displayed.

Print Processing

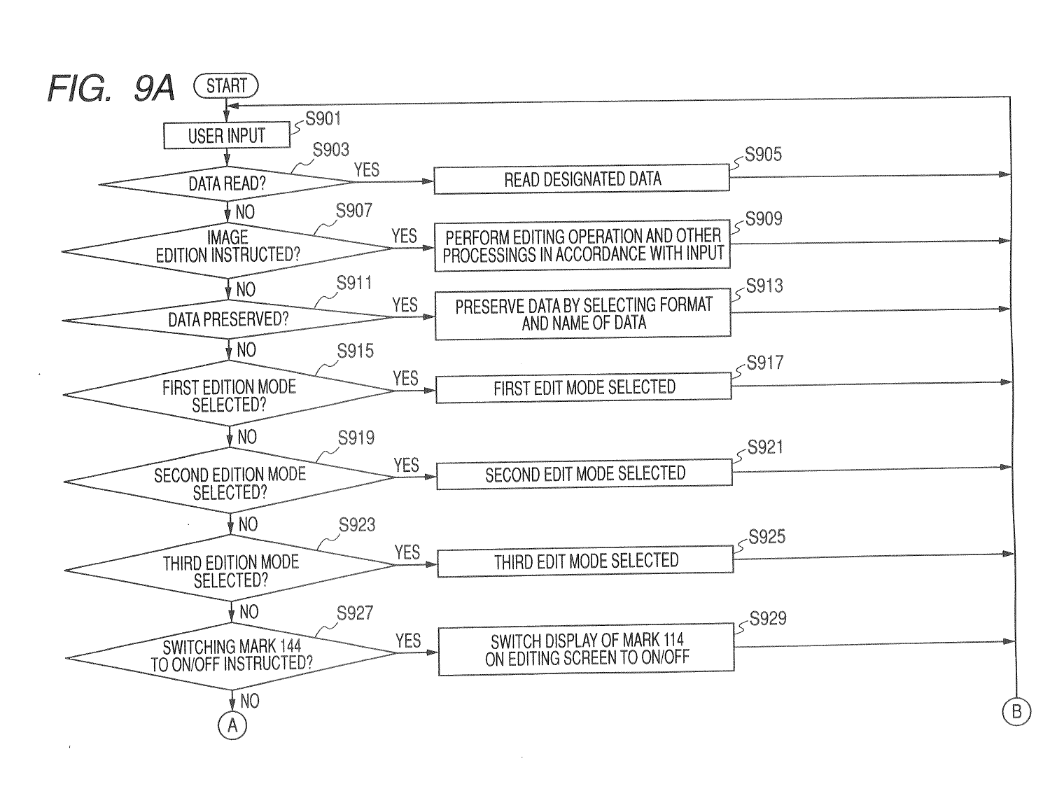

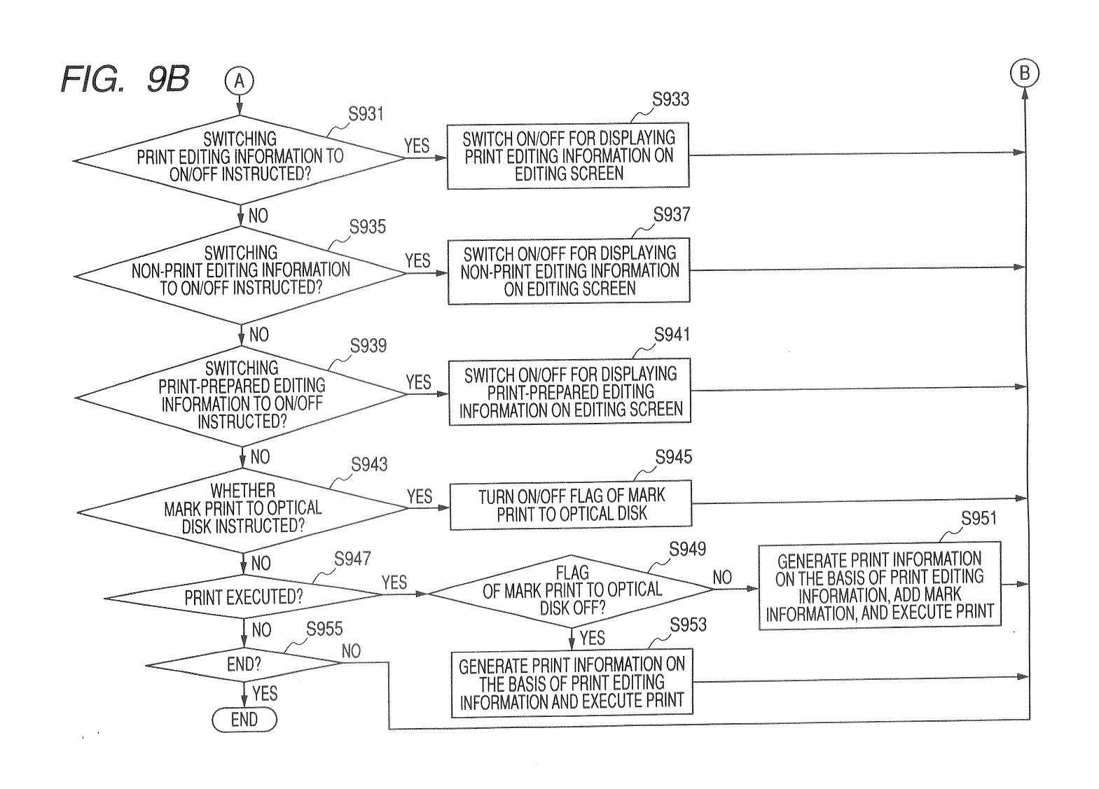

Next, referring to FIGS. 9A and 9B, the embodiment describes the print processing in the printing system 100. FIGS. 9A and 9B are flowcharts illustrating schematic print processings in the printing system according to the embodiment of the invention.

As shown in FIG. 9A, first, the user requests any processing by manipulating the input unit 208 (S901). The requested content is received by the request reception module 305.

When the request input by the user (S901) is a request for reading a series of editing information such as the print editing information displayed on the editing screen (S903), the data management module 309 reads the editing information designated by the user (S905).

The editing information read by the data management module 309 in step S905 is displayed on the editing screen of the display unit 210 as described above.

A reading location where the data management module 309 reads the editing information may include the optical disk 141, a server on Internet, the storage device 211, or the removable recording media 177 other than the optical disk 141 which is the printing medium.

In step S903, when the editing information to be read does not exist, the print editing information is newly generated by the editing information generating module 301.

Next, when the request input by the user (S901) is a request for editing the object displayed on the editing screen (S907), the editing information processing module 311 edits the object depending on the user's command (S909).

Next, when the request input by the user (S901) is a request for preserving the editing information including at least one of the print editing information, the non-print editing information, or the print-prepared editing information (S911), the data management module 309 converts the editing information to a designated data format and gives a designated file name to the editing information to preserve the editing information (S913).

Similarly to the reading location in step S903 described above, a preserving location where the data management module 309 preserves the editing information may include the optical disk 141, the server on Internet, the storage device 211, or the removable recording media 177 other than the optical disk 141 serving as the printing medium.

Next, when the request input by the user (S901) is a request for selecting a mode (first edit mode) of editing the object including the print editing information (S915), the mode selecting module 313 notifies the gist of selecting the first edit mode to the editing information processing module 311 and permits the editing information processing module 311 to edit the object involved in the print editing information (S917).

When the request input by the user (S901) is a request for selecting a mode (second edit mode) of editing the object involved in the non-print editing information (S919), the mode selecting module 313 notifies the gist of selecting the second edit mode to the editing information processing module 311 and permits the editing information processing module 311 to edit the object involved in the non-print editing information (S921).

Next, when the request input by the user (S901) is a request for selecting a mode (third edit mode) of editing the object involved in the print-prepared editing information (S923), the mode selecting module 313 notifies the gist of selecting the third edit mode to the editing information processing module 311 and permits the editing information processing module 311 to edit the object involved in the print-prepared editing information (S925).

Next, when the request input by the user (S901) is a display switching request for whether to display the mark 144 on the editing screen (S927), the display switching module 315 transmits whether the display data about the mark 144 is generated to the display data generating module 303 depending on a user's request for the “ON” or “OFF” display of the mark 144 (S929).

Next, as shown in FIG. 9B, when the request input by the user (S901) is a display switching request for whether to display the print editing information on the editing screen (S931), the display switching module 315 transmits whether the display data about the print editing information is generated to the display data generating module 303 depending on a user's request for the “ON” or “OFF” display of the print editing information (S933).

The display data generating module 303 displays the object of the print editing information on the editing screen depending on a command from the display switching module. Alternatively, the display data generating module 303 does not display the object of the print editing information on the editing screen.

Next, when the request input by the user (S901) is a display switching request for whether to display the non-print editing information on the editing screen (S935), the display switching module 315 transmits whether the display data about the non-print editing information is generated to the display data generating module 303 depending on a user's request for the “ON” or “OFF” display of the non-print editing information (S937).

The display data generating module 303 displays the object of the non-print editing information on the editing screen depending on a command from the display switching module. Alternatively, the display data generating module 303 does not display the object of the non-print editing information on the editing screen.

Next, when the request input by the user (S901) is a display switching request for whether to display the print-prepared editing information on the editing screen (S939), the display switching module 315 transmits whether the display data about the print-prepared editing information is generated to the display data generating module 303 depending on a user’request for the “ON” or “OFF” display of the print-prepared editing information (S941).

The display data generating module 303 displays the area or the object of the print-prepared editing information on the editing screen depending on a command from the display switching module. Alternatively, the display data generating module 303 does not display the area or the object of the print-prepared editing information on the editing screen.

Next, when the request input by the user (S901) is a mark printing request for whether to print the mark 143 on the optical disk 141 (S943), the print information generating module 307 sets a flag about the mark printing depending on a user's request for the necessity or the unnecessity of the mark printing (S945).

For example, the flag about the mark printing may be any one of the editing information, but it is not limited to the example. As shown in FIG. 9B, when the flag is set to “ON”, the printing of the mark 143 is required and when the flag is set to “OFF”, the printing of the mark 143 is not required.

Next, when the request input by the user (S901) is a request for performing the printing operation on the label surface of the optical disk 141 (S947), the print information generating module 307 generates the print information and the print information for printing the mark 143 on the basis of the print editing information when the flag is set to “ON” (S949) by referring to the flag set in step S945 (S951).

When the flag referred in step S949 is set to “OFF”, the print information generating module 307 generates the print information on the basis of the print editing information (S953).

Last, when the request input by the user (S901) is a request for ending a print processing of the label surface of the optical disk 141 via the editing screen (S955), a series of print processings in the printing system 100 according to the embodiment of the invention is ended.

The series of print processings enable performing the printing operation on the label surface of the optical disk 141 by plural times in accordance with the layout of the label surface on the editing screen. Hereinafter, a detailed content of multiple printing operations will be described.

Multiple Printing Operations

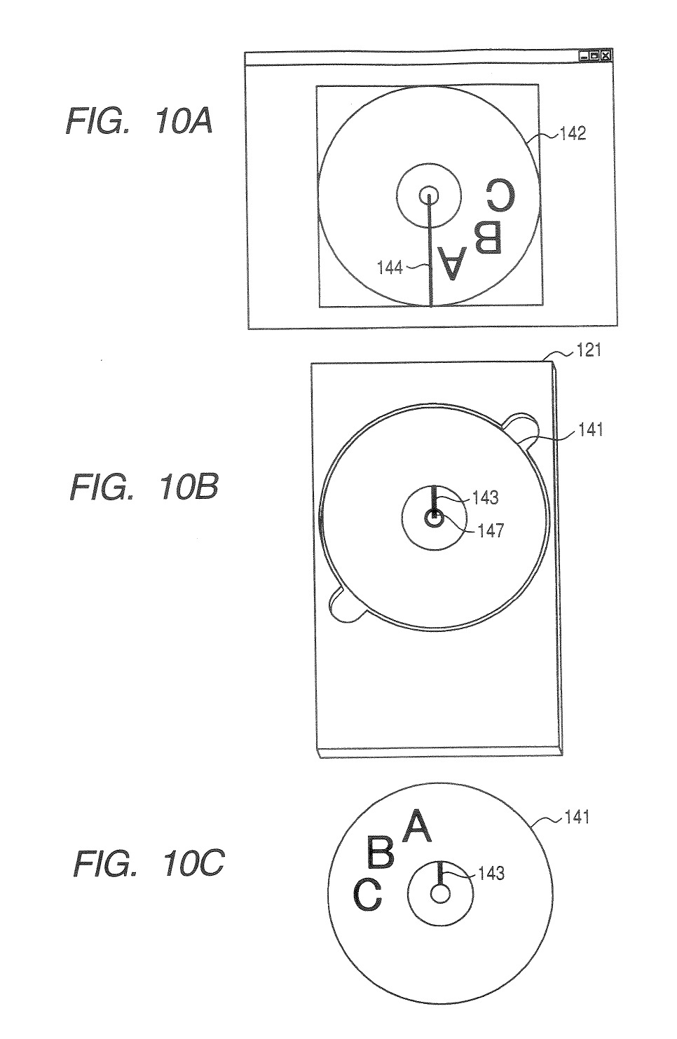

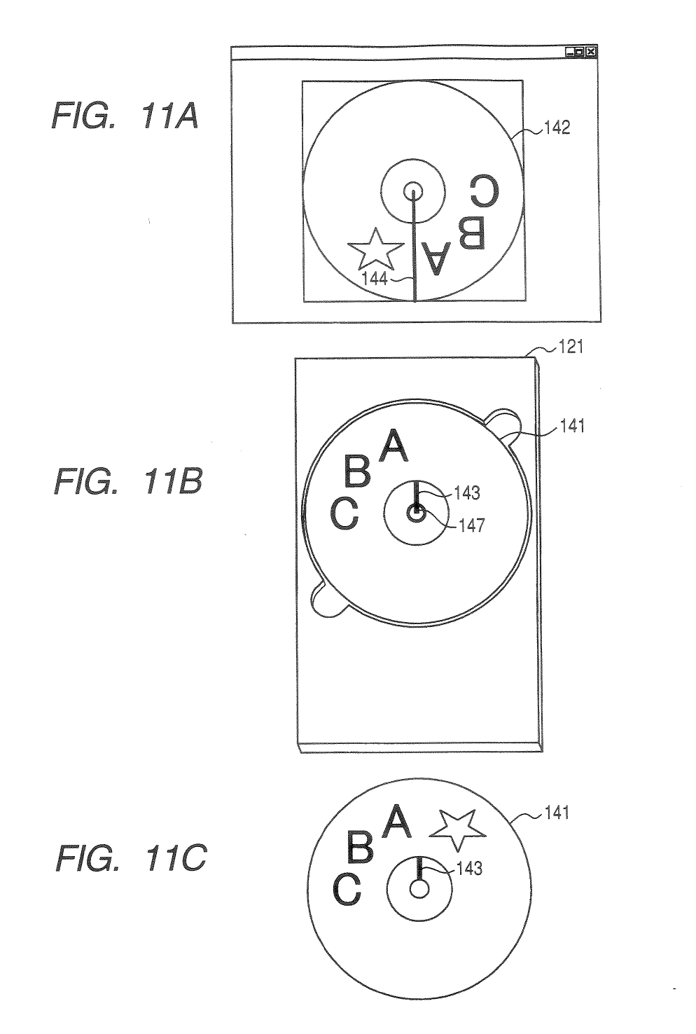

Next, referring to FIGS. 10 and 11, the embodiment describes the multiple print processings for performing the printing operation on the label surface of the optical disk 141 by plural times. FIGS. 10 and 11 are explanary views illustrating schematic multiple print processings on the label surface of the optical disk according to the embodiment of the invention.

As shown in FIG. 10A, the editing screen of the display unit 210 displays the virtual optical disk 142, the mark 144, and the object (“ABC” shown in FIG. 10A) involved in the print editing information.

Next, as shown in FIG. 10B, the optical disk 141 is attached to the print tray 121 of the printer 101 so that the attachment mark 147 and the mark 143 are matched with each other. Since nothing is printed on the label surface of the attached optical disk 141, this printing operation is a first printing operation.

Next, as shown in FIGS. 10A and 10B, when the user requests for printing by manipulating the input unit 208, the print information is generated on the basis of the print editing information including “ABC” of FIG. 10A as described above and “ABC” is printed on the label surface of the optical disk 141 as shown in FIG. 10C.

As described above, the first print processing is ended. Next, when a second print processing is performed on the label surface of the optical disk 141 printed “ABC”, the second printing is performed as shown in FIG. 11.

As shown in FIG. 11A, first, the data management module 309 reads the editing information including the non-print editing information preserved in the first print processing as described above. The read editing information is displayed on the editing screen of the display unit 210.

As shown in FIG. 11A, “ABC” printed on the label surface by the first print processing is displayed on the editing screen as the non-print editing information.

Next, the editing information processing module 311 prepares and disposes the object “⋆” as the object of the print editing information depending on the user's request. Accordingly, as shown in FIG. 11A, “⋆” and “ABC” are displayed on left and right sides of the mark 144 on the editing screen.

As described above, it is possible to layout the objects so as not to be overlapped with the previously-printed object and to accurately and efficiently determine the layout of the label surface by preparing and disposing the object of the print editing information on the basis of the object (object or area of the print-prepared editing information) involved in the mark 144 and the non-print editing information on the editing screen.

Next, as shown in FIG. 11B, the previous optical disk 141 firstly printed is attached to the print tray 121 of the printer 101 so that the attachment mark 147 and the mark 143 are matched with each other.

Since the mark 143 and the attachment mark 147 of the optical disk 141 are overlapped with each other, the direction of the optical disk 141 and the attachment direction of attaching the optical disk 141 to the print tray 121 are constantly the same as each other. Accordingly, it is possible to relatively match the printing position, size, and range on the label surface of the optical disk 141 with the printing position, size, and range on the label surface of the editing screen.

Next, as shown in FIGS. 11A and 11B, when the user requests for performing the printing operation by manipulating the input unit 208, the print information is generated on the basis of the print editing information including “⋆” of FIG. 11A as described above and “⋆” is newly printed on the label surface of the optical disk 141 on which “ABC” has been previously printed as shown in FIG. 11C.

As described above, in the multiple print processings of the embodiment, since the layout of the printing label surface can be determined on the basis of the non-print editing information and the print-prepared editing information and the printing can be performed in accordance with the layout on the editions screen, it is possible to perform the printing operation by plural times.

The series of processings described above may be performed by a special hardware and may be performed by software. When the series of processings are performed by the software, a program constituting the software is installed in a general-purpose computer or a micro computer and enables the computer or the micro computer to serve as the information processor 105.

The program may be previously recorded in a hard disk drive or a ROM as a recording medium built in the computer.

The program is not limited to the hard disk drive. The program may be temporarily or successively stored (recorded) in the removable recording medium such as a flexible disk, a CD-ROM (Compact Disc Read Only Memory), an MO (Magneto Optical) disk, a DVD (Digital Versatile Disc), a magnetic disk, or a semiconductor memory. The removable recording medium may be provided as so-called package software.

The program is installed in the computer from the removable recording medium described above, is wirelessly transmitted to the computer via a satellite for a digital satellite broadcasting, or is on a wired line transmitted to the computer via the network such as LAN (Local Area Network) or Internet from a download site. The computer receives the program thus transmitted and installs the received program in the hard disk drive built therein.

Herein, in the specification, a processing step of specifying a program enabling the computer to perform various processings needs not to be time-sequentially processed depending on a sequence described in a flowchart and may include processings (for example, a parallel processing or a processing by the object) performed parallely or separatively.

The program may be processed by one computer and may be distributively processed by a plurality of computers.

As described above, referring to the accompanying drawings, the embodiments suitable for the invention are described, but the invention is not limited to the example. It should be understood by those skilled in the art that various modifications, combinations, sub-combinations, and alternations may occur depending on design requirements and other factors insofar as they are within the scope of the appended claims or the equivalents thereof.

In the embodiment, a case where the printing medium to be printed by plural times is the optical disk 141 such as the CD-ROM is exemplified, but the invention is not limited to the example. For example, the printing can be performed in all media including the paper medium, and the like.

A case where the modules (editing information generating module 301, display data generating module 303, request reception module 305, print information generating module 307, data management module 309, editing information processing module 311, mode selecting module 313 and display switching module 315) serving as the information processor 105 serve as software is exemplified, but the invention is not limited to the example. For example, at least one of the editing information generating module 301, the display data generating module 303, the request reception module 305, the print information generating module 307, the data management module 309, the editing information processing module 311, the mode selecting module 313, and the display switching module 315 may be formed of the hardware.

In the embodiment, a case where the printing system 100 includes the printer 101 and the information processor 105 is exemplified, but it is not limited to the example. For example, even when the printing system 100 includes only the printer 101, it is possible to perform the printing operation. In this case, the printer 101 includes at least one of functions of the information processor 105.

As described above, according to the embodiments of the invention, even though performing the printing operation on the same printing medium by plural times, it is possible to perform the printing operation on the printing medium in accordance with the layout of performing the printing operation on the printing medium.

It should be understood by those skilled in the art that various modifications, combinations, sub-combinations, and alterations may occur depending on design requirements and other factors insofar as they are within the scope of the appended claims or the equivalents thereof.

What is claimed is:

1. A printing system comprising:
a printer performing a printing operation on a printing medium; and
an information processor transmitting print information used for the printer to perform the printing operation on the printing medium,
wherein the printer includes
supporting means for supporting the printing medium for the printing operation and
printing means for performing the printing operation on the printing medium on the basis of the print information,
wherein the information processor includes
editing information processing means for generating or processing editing information on the edition of a layout of the printing medium as information for performing the printing operation on the same printing medium by plural times,
display means for displaying the editing information generated or processed by the editing information processing means, and
print information generating means for generating the print information on the basis of the editing information when a user requests for performing the printing operation on the printing medium, and
wherein the supporting means has a direction matching mechanism matching an attachment direction of attaching the printing medium to the supporting means and the direction of the printing medium and the editing information processing means generates mark information serving as a reference for specifying a direction of the printing medium corresponding to the direction of the printing medium attached to the supporting means in a first mode and transmits the mark information to the display means so as to edit the layout of the printing medium on the basis of the mark information.

2. The printing system according to claim 1, wherein the display means switches the mark information generated by the editing information processing means between a display state and a non-display state on an editing screen.

3. The printing system according to claim 1, wherein the direction of the printing medium is specified by a mark existing on the printing medium.

4. The printing system according to claim 1, wherein the editing information processing means generates or processes print editing information for editing an object to be printed on the printing medium in a second mode.

5. The printing system according to claim 4, wherein the display means switches the print editing information generated or processed by the editing information processing means between a display state and a non-display state on the editing screen.

6. The printing system according to claim 1, wherein the editing information processing means generates or processes non-print editing information on a non-print object which is not printed on the printing medium as an object on the editing screen in a third mode.

7. The printing system according to claim 6, wherein the display means switches the non-print editing information generated or processed by the editing information processing means between a display state and a non-display state on the editing screen.

8. The printing system according to claim 6, wherein the non-print editing information is information on an object having been previously printed on the printing medium.

9. The printing system according to claim 6, wherein the non-print editing information is at least information indicating an area to be printed on the printing medium.

10. The printing system according to claim 1, further comprising mode selecting means for selecting any one of a second mode for generating or processing the print editing information for editing the object to be printed on the printing medium and a third mode for generating or processing the non-print editing information on the non-print object not to be printed on the printing medium,
wherein the editing information processing means generates or processes editing information corresponding to the mode selected by the mode selecting means.

11. The printing system according to claim 1, wherein the editing information processing means judges whether the object to be printed on the printing medium and the non-print object not to be printed on the printing medium are overlapped with each other and generates overlap information indicating an overlapped part when it is judged that the objects are overlapped with each other, and
wherein the display means displays the overlap information generated by the editing information processing means on the editing screen.

12. The printing system according to claim 3, wherein the display means displays mark printing or non-printing reception information for receiving whether the mark should be printed on the printing medium.

13. The printing system according to claim 3, wherein the printing means prints the mark on the printing medium when the mark does not exist on the printing medium.

14. An information processor generating print information for performing a printing operation on a printing medium, the information processor comprising:
editing information processing means for generating or processing editing information on the edition of a layout of the printing medium as information for performing a printing operation on the same printing medium by plural times;
display means for displaying the editing information generated or processed by the editing information processing means on an editing screen; and
print information generating means for generating the print information on the basis of the editing information when a user requests for performing the printing operation on the printing medium,
wherein the printing medium is supported by supporting means disposed in a printer and an attachment direction of attaching the printing medium to the supporting means and a direction of the printing medium are matched with each other, and
wherein the editing information processing means generates mark information serving as a reference for specifying the direction of the printing medium corresponding to the direction of the printing medium attached to the supporting means and transmits the mark information to the display means so as to edit the layout of the printing medium on the basis of the mark information, in a first mode.

15. The information processor according to claim 14, wherein the display means switches the mark information generated by the editing information processing means between a display state and a non-display state on the editing screen.

16. The information processor according to claim 14, wherein the editing information processing means generates or processes the print editing information for editing the object to be printed on the printing medium in a second mode.

17. The information processor according to claim 16, wherein the display means switches the print editing information generated or processed by the editing information processing means between a display state and a non-display state on the editing screen.

18. The information processor according to claim 14, wherein the editing information processing means generates or processes non-print editing information on a non-print object not to be printed on the printing medium as an object on the editing screen in a third mode.

19. The information processor according to claim 18, wherein the display means switches the non-print editing information generated or processed by the editing information processing means between a display state and a non-display state on the editing screen.

20. The information processor according to claim 18, wherein the non-print editing information is information on an object having been previously printed on the printing medium.

21. The information processor according to claim 18, wherein the non-print editing information is at least information indicating an area to be printed on the printing medium.

22. The information processor according to claim 14, further comprising mode selecting means for selecting at least one of a second mode for generating or processing the print editing information for editing the object to be printed on the printing medium and a third mode for generating or processing the non-print editing information on the non-print object not to be printed on the printing medium,
wherein the editing information processing means generates or processes the editing information corresponding to the mode selected by the mode selecting means.

23. The information processor according to claim 14, wherein the editing information processing means judges whether an object to be printed on the printing medium and a non-print object not to be printed on the printing medium are overlapped with each other and generates overlap information indicating an overlapped part when it is judged that the objects are overlapped with each other, and
wherein the display means displays the overlap information generated by the editing information processing means on the editing screen.

24. The information processor according to claim 14, wherein the display means displays mark printing or non-printing reception information for receiving whether the mark for specifying the direction of the printing medium is printed on the printing medium.

25. A printer for reading print information and performing a printing operation on a printing medium, the printer comprising:
supporting means for supporting the printing medium for the printing operation; and
printing means for performing the printing on the printing medium on the basis of the print information,
wherein the print information is generated on the basis of editing information on the edition of a layout of the printing medium at the time of performing the printing operation on the same printing medium by plural times, and
wherein the supporting means includes a direction matching mechanism matching a direction of attaching the printing medium to the supporting means with a direction of the printing medium.

26. The printer according to claim 25, wherein the direction of the printing medium is specified by a mark existing on the printing medium.

27. The printer according to claim 26, wherein the mark is a radial line segment from the center of the printing medium.

28. The printer according to claim 26, wherein the printing means prints the mark on the printing medium when the mark does not exist on the printing medium.

29. A printing medium on which a printer reading print information performs a printing operation, wherein the printer includes supporting means for supporting the printing medium for the printing operation and printing means for performing the printing operation on the printing medium on the basis of the print information,
wherein the print information is generated on the basis of editing information on the edition of a layout of the printing medium as information for performing the printing operation on the same printing medium by plural times, and
wherein a mark for clearly specifying a direction of the printing medium exists on the printing medium so as to match an attachment direction of attaching the printing medium to the supporting means with the direction of the printing medium.

30. A computer-readable program enabling a computer to serve as an information processor generating print information for performing the printing operation on a printing medium, the computer-readable program comprising:
an editing information processing function of generating or processing editing information on the edition of a layout of the printing medium as information for printing the same printing medium by plural times;
a display function of displaying the editing information generated or processed by the editing information processing function on an editing screen; and
a print information generating function of generating the print information on the basis of the editing information when a user requests for performing the printing operation on the printing medium,
wherein the printing medium is supported by supporting means disposed in a printer and an attachment direction of attaching the printing medium to the supporting means and a direction of the printing medium are matched with each other, and
wherein the editing information processing function generates mark information serving as a reference for specifying a direction of the printing medium corresponding to the direction of the printing medium attached to the supporting means and transmits the mark information to the display function so as to edit the layout of the printing medium on the basis of the mark information, in a first mode.

31. A printing system comprising:
a printer performing a printing operation on a printing medium; and
an information processor transmitting print information used for the printer to perform the printing operation on the printing medium,
wherein the printer includes
a supporting section supporting the printing medium for the printing operation and
a printing section performing the printing operation on the printing medium on the basis of the print information,
wherein the information processor includes
an editing information processing section generating or processing editing information on the edition of a layout of the printing medium as information for performing the printing operation on the same printing medium by plural times,
a display section displaying the editing information generated or processed by the editing information processing section, and
a print information generating section generating the print information on the basis of the editing information when a user requests for performing the printing operation on the printing medium, and
wherein the supporting section has a direction matching mechanism matching an attachment direction of attaching the printing medium to the supporting section and the direction of the printing medium and the editing information processing section generates mark information serving as a reference for specifying a direction of the printing medium corresponding to the direction of the printing medium attached to the supporting section in a first mode and transmits the mark information to the display section so as to edit the layout of the printing medium on the basis of the mark information.

32. An information processor generating print information for performing a printing operation on a printing medium, the information processor comprising:
an editing information processing section generating or processing editing information on the edition of a layout of the printing medium as information for performing a printing operation on the same printing medium by plural times;
a display section displaying the editing information generated or processed by the editing information processing section on an editing screen; and
a print information generating section generating the print information on the basis of the editing information when a user requests for performing the printing operation on the printing medium,
wherein the printing medium is supported by supporting section disposed in a printer and an attachment direction of attaching the printing medium to the supporting section and a direction of the printing medium are matched with each other, and
wherein the editing information processing section generates mark information serving as a reference for specifying the direction of the printing medium corresponding to the direction of the printing medium attached to the supporting section and transmits the mark information to the display section so as to edit the layout of the printing medium on the basis of the mark information, in a first mode.

33. A printer for reading print information and performing a printing operation on a printing medium, the printer comprising:
a supporting section supporting the printing medium for the printing operation; and
a printing section performing the printing on the printing medium on the basis of the print information,
wherein the print information is generated on the basis of editing information on the edition of a layout of the printing medium at the time of performing the printing operation on the same printing medium by plural times, and
wherein the supporting section includes a direction matching mechanism matching a direction of attaching the printing medium to the supporting section with a direction of the printing medium.

34. A printing medium on which a printer reading print information performs a printing operation, wherein the printer includes supporting section for supporting the printing medium for the printing operation and printing section for performing the printing operation on the printing medium on the basis of the print information,
wherein the print information is generated on the basis of editing information on the edition of a layout of the printing medium as information for performing the printing operation on the same printing medium by plural times, and
wherein a mark for clearly specifying a direction of the printing medium exists on the printing medium so as to match an attachment direction of attaching the printing medium to the supporting section with the direction of the printing medium.
